(19) United States
(12) Patent Application Publication
(10) Pub. No.: US 2026/0316539 A1
(43) Pub. Date: Oct. 15, 2026

(54) MOTOR UNIT MOUNTING STRUCTURE IN VEHICLE

(71) Applicant: TOYOTA JIDOSHA KABUSHIKI KAISHA, Toyota-shi (JP)

(72) Inventors: Katsuhiro SAKURAI, Toyota-shi (JP); Koji MATSUEDA, Toyota-shi (JP)

(73) Assignee: TOYOTA JIDOSHA KABUSHIKI KAISHA, Toyota-shi (JP)

(21) Appl. No.: 19/306,222

(22) Filed: Aug. 21, 2025

(30) Foreign Application Priority Data
Nov. 29, 2024 (JP) 2024-208729

(51) Int. Cl. B60K 1/00

(52) U.S. Cl. CPC B60K 1/00

(57) ABSTRACT

A motor unit mounting structure including a structural member integrally molded by casting, and a motor unit provided on an inner side of the structural member in a vehicle width direction, in which the structural member includes an upright wall portion that has a through hole through which a bolt is passed and that faces the motor unit in the vehicle width direction, and a rib protruding to a predetermined height on an outer face of the upright wall portion, toward an outer side in the vehicle width direction, in a vicinity of the through hole, and the motor unit has a fastening hole, of which a downstream side in a bolt fastening direction is an internal thread portion, and an upstream side in the bolt fastening direction is an enlarged portion of which an inner diameter is larger than an outer diameter of a shaft of the bolt.

### CROSS-REFERENCE TO RELATED APPLICATION

This application claims priority to Japanese Patent Application No. 2024-208729 filed on Nov. 29, 2024. The disclosure of the above-identified application, including the specification, drawings, and claims, is incorporated by reference herein in its entirety.

### BACKGROUND

### 1. Technical Field

The present disclosure relates to a motor unit mounting structure in a vehicle.

### 2. Description of Related Art

An arrangement has been conventionally known in which structural members making up a vehicle body are integrally molded, including shapes of each of the parts (e.g., see Japanese Unexamined Patent Application Publication No. 2021-127097 (JP 2021-127097 A)).

### SUMMARY

Now, vehicles such as battery electric vehicles or the like are equipped with a motor unit. The motor unit has a case that is made of metal, such as an aluminum alloy or the like, and in order to attach the motor unit to a structural member of the vehicle body, a bolt is fastened (screwed) into an internal thread portion that is formed in the case. Now, when the bolt happens to be inserted at an angle into the internal thread portion, in the aluminum case, the bolt will damage the internal thread portion, and the bolt cannot be fastened (screwed). Accordingly, a worker first loosely screws the bolt by hand into the internal thread portion, and then uses an impact wrench to fully tighten the bolt to the internal thread portion.

On the other hand, there is a vehicle body structural member that is called a “gigacast component”, which is made by integrally forming a plurality of parts by casting using a metal such as an aluminum alloy or the like, by casting technology called “gigacasting”. In order to reinforce the gigacast component, a plurality of ribs may be formed protruding to a predetermined height. Accordingly, when the rib for reinforcing is formed in the vicinity of a through hole for inserting the bolt to fasten the motor unit to the gigacast component, it becomes difficult for the hand of the worker to reach the through hole. That is to say, it becomes difficult for the worker to manually loosely screw the bolt into the internal thread portion of the motor unit through the through hole.

In a case in which the worker is unable to manually loosely screw the bolt into the internal thread portion by hand and instead has to directly fasten (screw) the bolt into the internal thread portion using an impact wrench, and the bolt is inserted at an angle into the internal threaded portion, the bolt will damage the internal threaded portion, and accordingly the bolt cannot be tightened (screwed). In this way, there are concerns about directly fastening bolts with an impact wrench when attaching the motor unit to the gigacast component.

Accordingly, an object of the present disclosure is to obtain a motor unit mounting structure in a vehicle, in which there are no concerns regarding bolt fastening when attaching a motor unit to a structural member that is integrally molded by casting, even when a rib protruding to a predetermined height is formed in the vicinity of a through hole for inserting a bolt in the structural member.

In order to achieve the above object, a motor unit mounting structure in a vehicle according to a first aspect of the present disclosure includes a structural member that is integrally molded by casting and that makes up both sides of a front-side portion of a vehicle body or both sides of a rear-side portion of the vehicle body, and a motor unit that is provided on an inner side of the structural member in a vehicle width direction, and that drives wheels, in which the structural member includes an upright wall portion that has a through hole through which a bolt for attaching the motor unit is passed, and that faces the motor unit in the vehicle width direction, and a rib protruding to a predetermined height on an outer face of the upright wall portion, toward an outer side in the vehicle width direction, in a vicinity of the through hole, and the motor unit has a fastening hole, of which a downstream side in a bolt fastening direction is an internal thread portion, and an upstream side in the bolt fastening direction is an enlarged portion of which an inner diameter is larger than an outer diameter of a shaft of the bolt, and that is opened in correspondence with the through hole.

According to the first aspect of the disclosure, the structural member making up the both sides of the front-side portion of the vehicle body or the both sides of the rear-side portion of the vehicle body is integrally molded by casting, and the motor unit for driving the wheels is provided on the inner side of the structural member in the vehicle width direction. Now, the structural member has the upright wall portion that faces the motor unit in the vehicle width direction, and the upright wall portion has the through hole through which the bolt for mounting the motor unit is inserted. The rib is provided on the outer face of the upright wall portion in the vicinity of the through hole, so as to protrude outward in the vehicle width direction to the predetermined height. The motor unit also has fastening holes formed in correspondence with the through hole of the structural member. The fastening hole has the internal thread portion on the downstream side in the bolt fastening direction and the enlarged portion with the inner diameter that is greater than the outer diameter of the shaft of the bolt on the upstream side in the bolt fastening direction.

Accordingly, in the vicinity of the through hole for inserting the bolt in the structural member that is integrally molded by casting, the rib is formed which protrudes to the predetermined height (to such a height that it is difficult for the worker to reach the through hole by hand), and even when the bolt has to be fastened to the internal thread portion of the fastening hole of the motor unit through the through hole with an impact wrench, the enlarged portion can suppress the bolt from inclining (being inserted at an angle). Accordingly, there is no concern about bolt fastening when attaching the motor unit to the structural member.

Also, the motor unit mounting structure for a vehicle according to a second aspect of the present disclosure is a motor unit mounting structure for a vehicle of the first aspect, in which a length and the inner diameter of the enlarged portion are set such that when the shaft of the bolt is passed into the internal thread portion, an inclination angle of the shaft of the bolt with respect to an axial line of the fastening hole is 3 degrees or less.

According to the second aspect of the disclosure, the length and inner diameter of the enlarged portion are set such that the inclination angle of the shaft of the bolt with respect to the axial line of the fastening hole when the shaft of the bolt is inserted into the internal thread portion is 3 degrees or less. Thus, the inclination of the bolt (insertion at an angle) is further suppressed as compared to when the length and the inner diameter of the enlarged portion are set such that the inclination angle thereof is greater than 3 degrees.

As described above, according to the present disclosure, even when the rib protruding to the predetermined height is formed in the vicinity of the through hole for inserting the bolt in the structural member that is integrally molded by casting, there are no concerns about bolt tightening when attaching the motor unit to the structural member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating a motor unit mounting structure according to an embodiment;

FIG. 2 is a schematic disassembled perspective view illustrating the motor unit mounting structure according to the embodiment;

FIG. 3 is a schematic side view illustrating the motor unit mounting structure according to the embodiment;

FIG. 4 is schematic sectional arrow view taken along line X-X in FIG. 3;

FIG. 5A is a schematic sectional view illustrating a fastening hole according to the embodiment; and

FIG. 5B is a schematic sectional view illustrating a state in which a bolt is inserted into the fastening hole according to the embodiment.

### DETAILED DESCRIPTION OF EMBODIMENTS

Hereinafter, an embodiment according to the present disclosure will be described in detail with reference to the drawings. Note that for the sake of convenience of description, in the drawings, an arrow UP indicates an upward direction of a vehicle, an arrow FR indicates a forward direction of the vehicle, an arrow LH indicates a leftward direction of the vehicle, and an arrow RH indicates a rightward direction of the vehicle, as appropriate. Also, when terms describing up-down, front-rear, and right-left directions are used in the following description without any particular specification, these mean up-down, front-rear, and right-left of the vehicle. Further, the right-left direction is synonymous with a vehicle width direction.

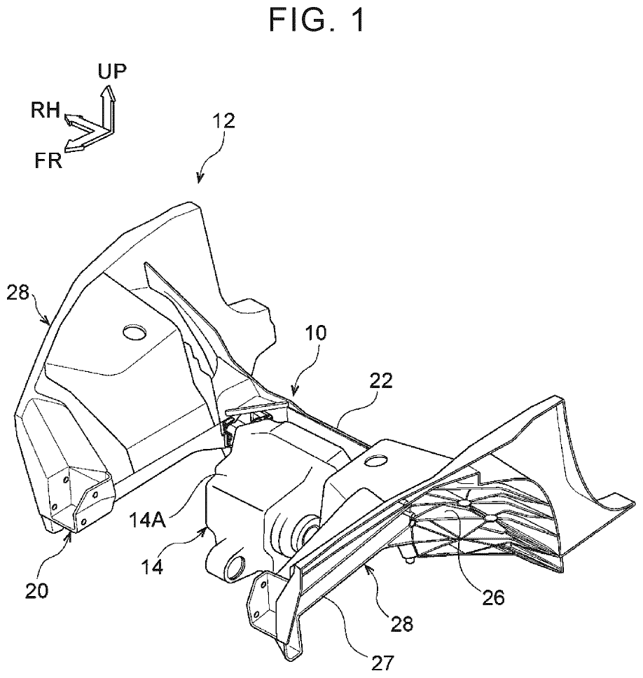

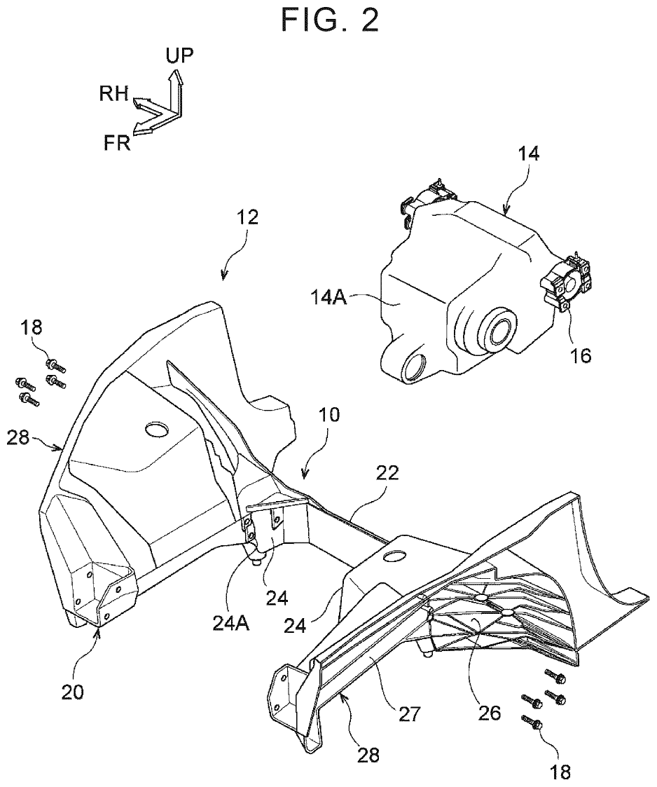

A vehicle 12 such as a battery electric vehicle or the like that is equipped with a motor unit mounting structure 10 according to the present embodiment has a structural member that forms both sides of a front-side portion and a structural member that forms both sides of a rear-side portion of a vehicle body. Here, the structural member that makes up the both sides of the front-side portion of the vehicle body (hereinafter referred to as “vehicle body front portion 20”), as illustrated in FIGS. 1 and 2 will be used as an example for description. The vehicle body front portion 20 is a cast article called a “gigacast component”, in which a plurality of parts is integrally formed by die casting, using a metal such as an aluminum alloy or the like, for example.

Both sides of the right and left side portions of the vehicle body front portion 20 are integrally linked together by a linking wall 22 that has a generally rectangular and flat shape and that is positioned in a middle portion in the vehicle width direction, and wheel houses 28 of symmetrical shapes that can accommodate each of right and left wheels (front wheels, omitted from illustration) are integrally formed on both sides of the right and left sides thereof. A motor unit 14 for driving the right and left wheels (front wheels) is provided on an inner side in the vehicle width direction of the vehicle body front portion 20 (on a front side of the linking wall 22).

The motor unit 14 has a case 14A made of metal, such as an aluminum alloy or the like, and at both right and left ends of the linking wall 22 in the vehicle body front portion 20, upright wall portions 24 that face the case 14A of the motor unit 14 in the vehicle width direction are integrally arrayed toward the forward side. Each of the upright wall portions 24 has a plurality of through holes 24A (. e.g., two on top and also on bottom, for a total of four) formed therein, through which bolts 18 for attaching the motor unit 14 to the vehicle body front portion 20 of the vehicle body are inserted, with the vehicle width direction being an axial direction thereof.

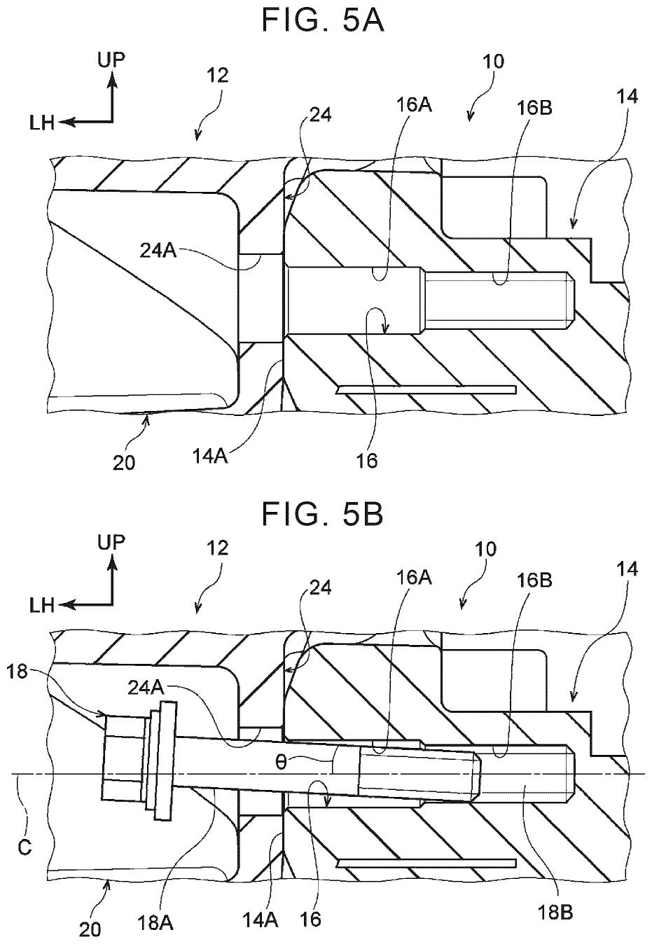

Note that as illustrated in FIG. 5B, the bolt 18 has an external thread portion 18B of a predetermined length that is formed only at a distal end portion of a shaft 18A thereof, and this external thread portion 18B is adapted to screw into (fasten to) an internal thread portion 16B of a fastening hole 16, which will be described later, that is formed in the case 14A of the motor unit 14.

Also, as illustrated in FIGS. 1 to 4, a plurality of ribs 26 is integrally formed on an outer face of each of the upright wall portions 24 and also in the vicinity each of the through holes 24A, protruding outward in the vehicle width direction to a predetermined height. Note that, a plurality of ribs 27 is also integrally formed on an outer face of each of the wheelhouses 28, so as to protrude outward in the vehicle width direction to a predetermined height. That is to say, multiple ribs 26 and 27, having a predetermined shape and protruding height, are integrally formed over substantially the entire outer faces of the vehicle body front portion 20. This provides a configuration in which the vehicle body front portion 20 is reinforced.

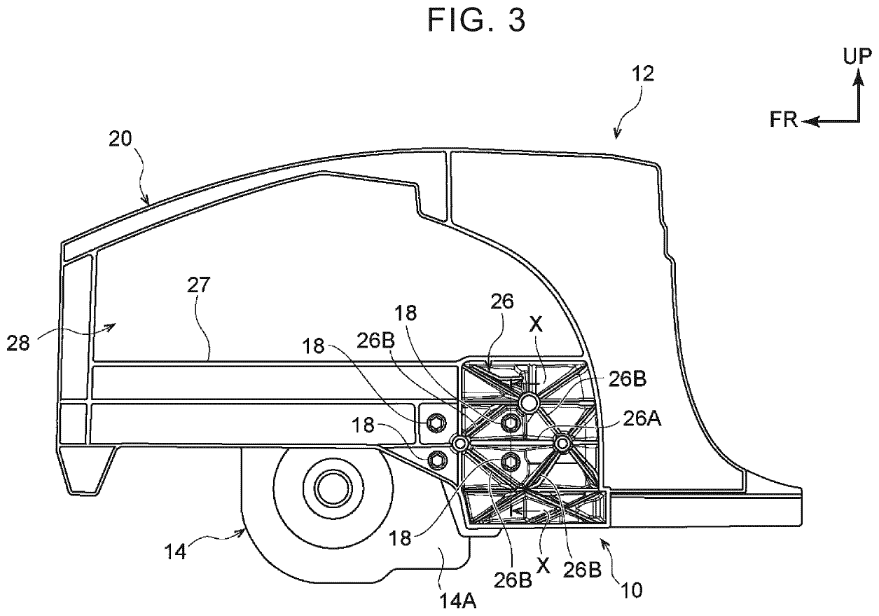

As illustrated in FIG. 3, the ribs 26 that are formed integrally on the outer face of each of the upright wall portions 24 are configured to include a plurality of lateral ribs 26A extending along the front-rear direction and a plurality of inclined ribs 26B extending along a direction inclined at an angle of approximately 45 degrees relative to the front-rear direction, which intersect with each other, as viewed from the side in the vehicle width direction. Some of the lateral ribs 26A and the inclined ribs 26B are configured to surround and partition off at least the upper and lower through holes 24A on the rear side.

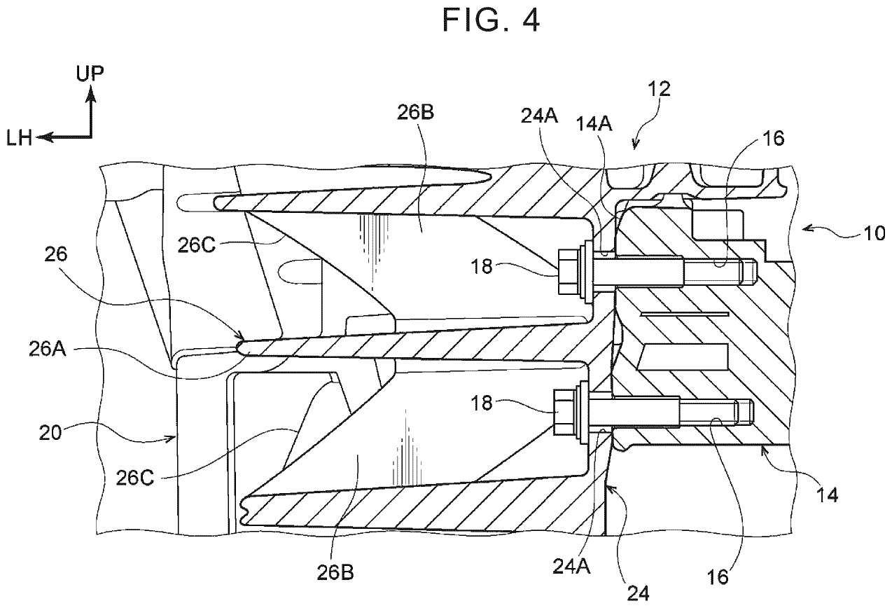

Accordingly, at least the upper and lower through holes 24A on the rear side are configured so as not to be readily accessible by the worker by hand, and cannot be reached. Note that as illustrated in FIG. 4, as viewed from the front-to-rear direction, the inclined ribs 26B have outer edges 26C thereof, formed inclined such that the protruding height on the lateral rib 26A side is lower than the protruding height above and below the lateral rib 26A.

As illustrated in FIGS. 2 and 4, at rear end portions of both side walls of the case 14A of the motor unit 14, a plurality of (four) fastening holes 16 that are not through holes, corresponding to each of the through holes 24A in the vehicle body front portion 20, is formed with the vehicle width direction as the axial direction thereof. As illustrated in FIG. 5A, the internal thread portion 16B is formed on a downstream side in a fastening direction of the bolt 18 in the fastening hole 16, and an enlarged portion 16A of a predetermined length is formed on an upstream side in the fastening direction of the bolt 18 in the fastening hole 16, having an inner diameter that is larger than an outer diameter of the shaft 18A of the bolt 18 excluding the external thread portion 18B (see FIG. 5B).

Here, as illustrated in FIG. 5B, the length and the inner diameter of the enlarged portion 16A are formed such that an inclination angle θ of the shaft 18A of the bolt 18 with respect to an axial line C of the fastening hole 16 when the external thread portion 18B of the shaft 18A of the bolt 18 is inserted into the internal thread portion 16B (before starting screwing) is 3 degrees or less. That is to say, the length and the inner diameter of the enlarged portion 16A are set appropriately in accordance with the length and the outer diameter of the shaft 18A (including external thread portion 18B) of the bolt 18 to be fastened into the fastening hole 16.

Next, operations of the motor unit mounting structure 10 according to the present embodiment that is configured as above will be described.

As described above, the vehicle body front portion 20, which is the structural member of the vehicle body, is integrally molded by casting (die casting) a metal such as an aluminum alloy or the like, and the motor unit 14 that drives the wheels (front wheels) is provided on the inner side of the vehicle body front portion 20 in the vehicle width direction.

Here, the vehicle body front portion 20 has the upright wall portions 24 that face the case 14A of the motor unit 14 in the vehicle width direction, and the upright wall portions 24 has the through holes 24A that are formed therein, through which the shafts 18A of the bolts 18 for attaching the motor unit 14 to the vehicle body front portion 20 are inserted. The ribs 26 are provided on the outer face of the upright wall portions 24 in the vicinity of the through holes 24A, protruding outward in the vehicle width direction to the predetermined height.

On the other hand, the case 14A of the motor unit 14 has fastening holes 16 that are formed in accordance with the through holes 24A in the vehicle body front portion 20. The fastening holes 16 have internal thread portions 16B on the downstream side in the fastening direction of the bolts 18 and the enlarged portions 16A with an inner diameter greater than the outer diameter of the shafts 18A of the bolts 18 on the upstream side in the fastening direction of the bolts 18.

Accordingly, in the vicinity of the through holes 24A for inserting the bolts in the vehicle body front portion 20, the ribs 26 are formed which protrude to a predetermined height, specifically to such a height that it is difficult for the worker to reach the through holes 24A by hand, and even when the external thread portions 18B of the shafts 18A of the bolts 18 have to be directly fastened to the internal thread portions 16B of the fastening holes 16 through the through holes 24A with an impact wrench omitted from illustration (the worker cannot screw by hand), the enlarged portions 16A can suppress the shafts 18A (external thread portions 18B) of the bolts 18 from inclining (being inserted at an angle to axial line C of fastening holes 16).

Accordingly, even when the motor unit 14 has the case 14A that is made of aluminum, at the time of the bolts being directly fastened from the outer wide in the vehicle width direction using an impact wrench, damage to the internal thread portions 16B by the shafts 18A (external thread portions 18B) of the bolts 18 can be suppressed, and the external thread portions 18B of the bolts 18 can be appropriately screwed into the internal thread portions 16B of the fastening holes 16. In other words, trouble in which the external thread portions 18B of the bolts 18 cannot be screwed into the internal thread portions 16B of the fastening holes 16 can be suppressed from occurring, and concerns regarding bolt fastening when attaching the motor unit 14 to the vehicle body front portion 20 can be kept from arising.

Moreover, the length and the inner diameter of the enlarged portions 16A are formed such that the inclination angle θ of the shafts 18A of the bolts 18 with respect to the axial line C of the fastening holes 16 when the shafts 18A (external thread portions 18B) of the bolts 18 are inserted into the internal thread portions 16B will be 3 degrees or less. Accordingly, as compared to when the length and the inner diameter of the enlarged portions 16A are formed such that the inclination angle θ is greater than 3 degrees, the inclination of the shafts 18A (external thread portions 18B) of the bolts 18 (insertion at an angle relative to the axial line C of fastening holes 16) can be further suppressed.

Furthermore, since direct bolt fastening with an impact wrench can be realized in this way without any concerns regarding the motor unit 14 with the case 14A that is made of aluminum, the worker can omit the task of loosely screwing the bolts 18 even when the ribs 26 are not formed on the outer faces of the upright wall portions 24 in the vicinity of the through holes 24A. Hence, efficiency of assembly work of the motor unit 14 to the vehicle body front portion 20 can be improved.

While the motor unit mounting structure 10 in the vehicle 12 according to the present embodiment has been described above with reference to the drawings, the motor unit mounting structure 10 according to the present embodiment is not limited to that illustrated in the drawings, and can be appropriately modified in design without departing from the spirit and scope of the present disclosure. For example, in the case of a motor unit (omitted from illustration) for driving right and left rear wheels, the motor unit is provided on the inner side in the vehicle width direction of a structural member (vehicle body rear portion, omitted from illustration) that makes up both sides of the rear-side portion of the vehicle body.

What is claimed is:

1. A motor unit mounting structure in a vehicle, the motor unit mounting structure comprising:
a structural member that is integrally molded by casting and that makes up both sides of a front-side portion of a vehicle body or both sides of a rear-side portion of the vehicle body; and
a motor unit that is provided on an inner side of the structural member in a vehicle width direction, and drives wheels, wherein the structural member includes
an upright wall portion that has a through hole through which a bolt for attaching the motor unit is passed, and that faces the motor unit in the vehicle width direction, and
a rib protruding to a predetermined height on an outer face of the upright wall portion, toward an outer side in the vehicle width direction, in a vicinity of the through hole, and
the motor unit has
a fastening hole, of which a downstream side in a bolt fastening direction is an internal thread portion, and an upstream side in the bolt fastening direction is an enlarged portion of which an inner diameter is larger than an outer diameter of a shaft of the bolt, and that is opened in correspondence with the through hole.

2. The motor unit mounting structure according to claim 1, wherein a length and the inner diameter of the enlarged portion are set such that when the shaft of the bolt is passed into the internal thread portion, an inclination angle of the shaft of the bolt with respect to an axial line of the fastening hole is 3 degrees or less.
